(19) United States
(12) Patent Application Publication
(10) Pub. No.: US 2019/0278146 A1
(43) Pub. Date: Sep. 12, 2019

(54) LIQUID CRYSTAL DISPLAY PANEL AND LIQUID CRYSTAL DISPLAY DEVICE

(71) Applicant: HKC Corporation Limited, Shenzhen City (CN)

(72) Inventor: HuaiLiang He, Shenzhen City (CN)

(21) Appl. No.: 16/337,542

(22) PCT Filed: Aug. 15, 2018
(86) PCT No.: PCT/CN2018/100586

§ 371 Date: Mar. 28, 2019

(30) Foreign Application Priority Data
Aug. 25, 2017 (CN) 201710744400.7

(51) Int. Cl. G02F 1/1362; G02F 1/13357; G02F 1/1339; G02F 1/1345; G02F 1/1368

(52) U.S. Cl. CPC G02F 1/136286; G02F 1/1336; G02F 2001/136222; G02F 1/13454; G02F 1/1368; G02F 1/13392

(57) ABSTRACT

The present application discloses a liquid crystal display panel and a liquid crystal display device adopting such liquid crystal display panel. The liquid crystal display panel includes an array substrate, including a drive circuit; an opposed substrate, opposite to the array substrate; a sealant, disposed between the array substrate and the opposed substrate, wherein the sealant, the array substrate and the opposed substrate define a containing space together, and the containing space includes a liquid crystal area and a liquid crystal-free area in parallel; and liquid crystal molecules, distributed in the liquid crystal area, wherein the drive circuit is located in the liquid crystal-free area.

### FIELD OF THE DISCLOSURE

The present application relates to the field of display, and particularly relates to a liquid crystal display panel and a liquid crystal display device.

### BACKGROUND

Liquid crystal display panels can be divided into a system on chip (SOC) type and a gate electrode driver on array (GOA) type according to a gate electrode driver design. Relative to the SOC type liquid crystal display panels, the GOA type liquid crystal display panels have narrower borders. With the scientific and technological progress and higher requirements of people on a visual effect, the narrow borders of the liquid crystal display panels are a mainstream trend in the future. Therefore, the GOA type liquid crystal display panels are a more important application than the SOC type liquid crystal display panels.

In an exemplary structure of the GOA type liquid crystal display panel, liquid crystal (LC) molecules are filled between upper and lower glass substrates and the periphery is sealed by a sealing material, such that the liquid crystal molecules are fully distributed above the GOA circuit. Wherein, liquid crystal is a high polymer material, and is widely applied to light and thin type display technologies due to its special physical, chemical and optical properties. The liquid crystal has the special optical properties and is sensitive to an electromagnetic field. Since the liquid crystal molecules exist above the GOA circuit in the exemplary structure, the components and parts in the GOA circuit are easily affected by the polarization of ions of the liquid crystal, direct current (DC) residual is caused. As a result, a signal bus line connected to the GOA circuit is affected by coupling, consequently, a load of the signal bus line is affected, and further actions of the GOA circuit are affected, which causes instable working of the GOA circuit.

### SUMMARY

Therefore, embodiments of the present application provide a liquid crystal display panel and a liquid crystal display device, which can enhance working stability of the GOA circuit.

In one aspect, there is provided a liquid crystal display panel. The liquid crystal display panel includes an array substrate, comprising a drive circuit; an opposed substrate, opposite to the array substrate; a sealant, disposed between the array substrate and the opposed substrate, wherein the array substrate, the opposed substrate and the sealant define a containing space together, the containing space comprises a liquid crystal area and a liquid crystal-free area in parallel, and the drive circuit is located in the liquid crystal-free area; and liquid crystal molecules, distributed in the liquid crystal area.

In an embodiment, the liquid crystal display panel includes an isolating structure, wherein the isolating structure is located above the drive circuit and is spaced from the drive circuit, and the isolating structure is located in the liquid crystal-free area.

In an embodiment, the isolating structure is of a plurality of spacers, and the plurality of spacers are fixedly connected to the opposed substrate, and extend to the drive circuit from the opposed substrate.

In an embodiment, the plurality of spacers are photosensitive spacers.

In an embodiment, the array substrate includes a pixel array circuit, the pixel array circuit is located in the liquid crystal area, and the drive circuit is connected to the pixel array circuit.

In an embodiment, the drive circuit includes an array substrate upper gate electrode driver, and the array substrate upper gate electrode driver is connected to the pixel array circuit.

In an embodiment, the drive circuit further includes a signal bus line, the signal bus line is connected to the array substrate upper gate electrode driver, and the signal bus line is used for providing a clock signal for the array substrate upper gate electrode driver.

In an embodiment, the array substrate upper gate electrode driver is located between the signal bus line and the pixel array circuit.

In an embodiment, the opposed substrate includes a light filter layer, and the light filter layer is located in the liquid crystal area.

In an embodiment, the light filter layer includes a red color photoresist, a green color photoresist and a blue color photoresist.

In an embodiment, the liquid crystal display panel includes a plurality of second spacers, wherein the plurality of second spacers are located in the liquid crystal area and extend to the pixel array circuit from the light filter layer, and the second spacers are used for maintaining a proper gap between the light filter layer and the pixel array circuit.

In an embodiment, the light filter layer includes a red color photoresist, a green color photoresist and a blue color photoresist, and the red color photoresist, the green color photoresist and the blue color photoresist correspond to the second spacers in a one-to-one manner.

In an embodiment, the plurality of liquid crystal molecules are located between the light filter layer and the pixel array circuit.

In an embodiment, the plurality of liquid crystal molecules are located between the light filter layer and the pixel array circuit, the liquid crystal display panel further includes a plurality of second spacers, the plurality of second spacers are located in the liquid crystal area and extend to the pixel array circuit from the light filter layer, and the second spacers are adjacent to the liquid crystal molecules.

The present application also provides a liquid crystal display device. The liquid crystal display device includes a backlight module, used for providing backlight illumination; and a liquid crystal display panel. The liquid crystal display panel includes an array substrate, including a drive circuit; an opposed substrate, opposite to the array substrate; a sealant, disposed between the array substrate and the opposed substrate, wherein the array substrate, the opposed substrate and the sealant define a containing space together, the containing space includes a liquid crystal area and a liquid crystal-free area, and the drive circuit is located in the liquid crystal-free area; and liquid crystal molecules, distributed in the liquid crystal area.

In an embodiment, the liquid crystal display device includes an isolating structure, wherein the isolating structure is located above the drive circuit and is spaced from the drive circuit, and the isolating structure is located in the liquid crystal-free area.

In an embodiment, the array substrate includes a pixel array circuit, the pixel array circuit is located in the liquid crystal area, and the drive circuit is connected to the pixel array circuit.

In an embodiment, the opposed substrate includes a light filter layer, and the light filter layer is located in the liquid crystal area, the plurality of liquid crystal molecules are located between the light filter layer and the pixel array circuit, a plurality of second spacers, wherein the plurality of second spacers are located in the liquid crystal area and extend to the pixel array circuit from the light filter layer, and the liquid crystal display panel also includes a plurality second spacers, the plurality of second spacers are located in the liquid crystal area and extend to the pixel array circuit from the light filter layer.

In an embodiment, the liquid crystal-free area surrounds the liquid crystal area.

The present application also provides a liquid crystal display device. The liquid crystal display device includes a backlight module, used for providing backlight illumination; and a liquid crystal display panel. The liquid crystal display panel includes an first substrate, including a active area and a peripheral area; a second substrate, opposite to the first substrate; an opposed substrate, opposite to the array substrate; a pixel array circuit, disposed on the active area of the first substrate; a drive circuit, disposed on the peripheral area of the first substrate, wherein the drive circuit is connected to drive the pixel array circuit; a liquid crystal layer, disposed between the active area of the first substrate and the second substrate, wherein the liquid crystal layer includes liquid crystal molecules, the pixel array circuit is used for controlling the plurality of liquid crystal molecules; an isolating structure, disposed on the second substrate and corresponding to the peripheral area, wherein the isolating structure is used for isolating the drive circuit and the liquid crystal layer; and a sealant, disposed on the peripheral area of the first substrate and the second substrate, wherein the first substrate, the second substrate and the sealant define a containing space together, and the drive circuit and the isolating structure are located in the liquid crystal-free area.

Based on the above liquid crystal display panel and liquid crystal display device, it can be known that by forming the liquid crystal-free area in the liquid crystal display panel, the drive circuit is isolated from the liquid crystal molecules, and the influence on the drive circuit caused by the polarization of ions of the liquid crystal can be avoided while the drive circuit is used to drive and control actions of the liquid crystal molecules. Therefore, the DC residual caused during drive control of the drive circuit can be avoided.

### BRIEF DESCRIPTION OF THE DRAWINGS

Accompanying drawings illustrated here are used for providing further understanding on the present application, and form part of the present application, and schematic embodiments and illustration thereof of the present application are used for explaining the present application rather than improperly limiting the present application.

FIG. 1 is a schematic view of an adopted SOC type liquid crystal display panel.

FIG. 2 is a schematic view of an adopted GOA type liquid crystal display panel.

FIG. 3 is a structural schematic view of a GOA type liquid crystal display panel according to an embodiment of the present application.

FIG. 4 is a structural schematic view of a liquid crystal display device according to an embodiment of the present application.

### DETAILED DESCRIPTION OF PREFERRED EMBODIMENTS

The specific structural and functional details disclosed herein are only representative and are intended for describing exemplary embodiments of the disclosure. However, the disclosure can be embodied in many forms of substitution, and should not be interpreted as merely limited to the embodiments described herein.

In the description of the disclosure, terms such as “center”, “transverse”, “above”, “below”, “left”, “right”, “vertical”, “horizontal”, “top”, “bottom”, “inside”, “outside”, etc. for indicating orientations or positional relationships refer to orientations or positional relationships as shown in the drawings; the terms are for the purpose of illustrating the disclosure and simplifying the description rather than indicating or implying the device or element must have a certain orientation and be structured or operated by the certain orientation, and therefore cannot be regarded as limitation with respect to the disclosure. Moreover, terms such as “first” and “second” are merely for the purpose of illustration and cannot be understood as indicating or implying the relative importance or implicitly indicating the number of the technical feature. Therefore, features defined by “first” and “second” can explicitly or implicitly include one or more the features. In the description of the disclosure, unless otherwise indicated, the meaning of “plural” is two or more than two. In addition, the term “comprise” and any variations thereof are meant to cover a non-exclusive inclusion.

In the description of the disclosure, is should be noted that, unless otherwise clearly stated and limited, terms “mounted”, “connected with” and “connected to” should be understood broadly, for instance, can be a fixed connection, a detachable connection or an integral connection; can be a mechanical connection, can also be an electrical connection; can be a direct connection, can also be an indirect connection by an intermediary, can be an internal communication of two elements. A person skilled in the art can understand concrete meanings of the terms in the disclosure as per specific circumstances.

The terms used herein are only for illustrating concrete embodiments rather than limiting the exemplary embodiments. Unless otherwise indicated in the content, singular forms “a” and “an” also include plural. Moreover, the terms “comprise” and/or “include” define the existence of described features, integers, steps, operations, units and/or components, but do not exclude the existence or addition of one or more other features, integers, steps, operations, units, components and/or combinations thereof.

The disclosure will be further described in detail with reference to accompanying drawings and preferred embodiments as follows.

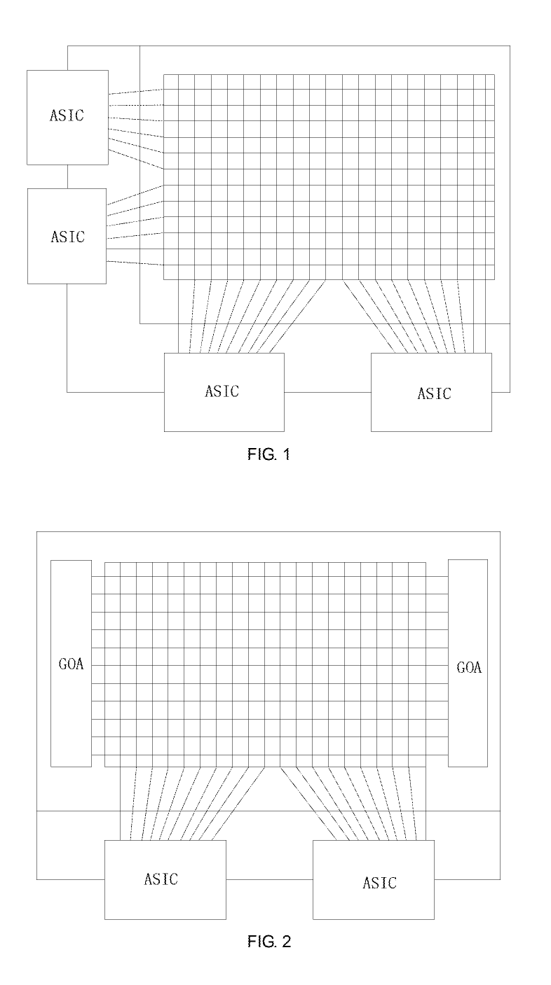

FIG. 1 shows a schematic view of an SOC type liquid crystal display panel, wherein a gate electrode driver of the SOC type liquid crystal display panel adopts an application specific integrated circuit (ASIC), but it is hard to enable the liquid crystal display panel to have a narrow border effect by adopting the ASIC circuit.

FIG. 2 shows a schematic view of a GOA type liquid crystal display panel, and a gate electrode driver thereof adopts a GOA circuit, such that the liquid crystal display panel has the narrow border effect.

However, in an exemplary GOA type liquid crystal display panel, liquid crystal molecules are filled between upper and lower glass substrates thereof, and the periphery is sealed by a sealing material, such that the liquid crystal molecules are fully distributed above the GOA circuit. As a result, the components and parts in the GOA circuit are easily affected by the polarization of ions of the liquid crystal, direct current residual is caused, a signal bus line connected to the GOA circuit is thus affected by coupling, and consequently, normal actions of the GOA circuit are affected, which causes instable working of the GOA circuit.

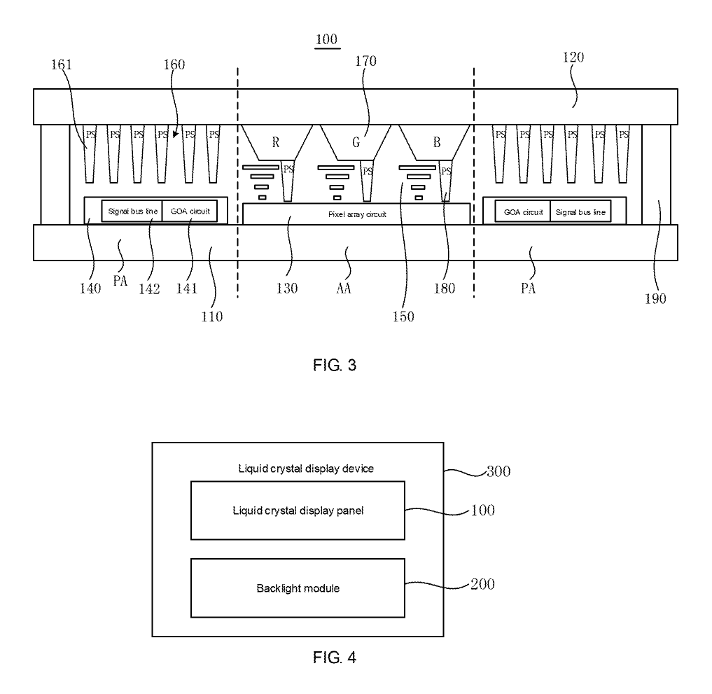

For this purpose, as shown in FIG. 3, the present embodiment provides a liquid crystal display panel 100, which can enhance working stability of a gate electrode drive circuit such as the GOA circuit. Specifically, the liquid crystal display panel 100 includes: a first substrate 110, having a active area and a peripheral area PA; a second substrate 120, opposite to the first substrate 110; a pixel array circuit 130, disposed on the first substrate 110 and located in the active area AA; a drive circuit 140, disposed on the first substrate 110 and located in the peripheral area PA, wherein the drive circuit 140 is connected to the pixel array circuit 130 and is used for driving the pixel array circuit 130; a liquid crystal layer 150, disposed between the first substrate 110 and the second substrate 120, wherein the liquid crystal layer 150 includes a plurality of liquid crystal molecules and the pixel array circuit 130 is used for controlling actions of the plurality of liquid crystal molecules; an isolating structure 160, disposed on the second substrate 120 and facing the drive circuit 140, wherein the isolating structure 160 is used for isolating the drive circuit 140 from the liquid crystal layer 150, to form a liquid crystal-free area above the drive circuit 140, or in other words, a liquid crystal-free area is formed between the drive circuit 140 and the second substrate 120; and a sealant 190, disposed in the peripheral area PA between the first substrate 110 and the second substrate 120 and surrounding the liquid crystal layer 150, wherein the drive circuit 140 is located between the sealant 190 and the active area AA.

The above liquid crystal display panel includes the first substrate, having the active area and the peripheral area; the second substrate, opposite to the first substrate; the pixel array circuit, disposed on the first substrate and located in the active area; the drive circuit, disposed on the first substrate and located in the peripheral area, wherein the drive circuit is connected to the pixel array circuit and is used for driving the pixel array circuit; the liquid crystal layer, disposed between the first substrate and the second substrate, wherein the liquid crystal layer includes a plurality of liquid crystal molecules and the pixel array circuit is used for controlling actions of the plurality of liquid crystal molecules; the isolating structure, disposed on the second substrate and facing the drive circuit, wherein the isolating structure is used for isolating the drive circuit from the liquid crystal layer; and the sealant, disposed in the peripheral area between the first substrate and the second substrate and surrounding the liquid crystal layer. Based on the above liquid crystal display panel, it can be known that by forming the isolating structure in the liquid crystal display panel, the drive circuit is isolated from the liquid crystal layer, the influence on the drive circuit caused by the polarization of ions in the liquid crystal layer can be avoided while the drive circuit is used to drive the pixel array circuit to control actions of the liquid crystal molecules so as to enable the liquid crystal layer to work, and further, the DC residual caused when the drive circuit drives the pixel array circuit is avoided.

As shown in FIG. 3, the first substrate 110 has the active area AA and the peripheral area PA, wherein the active area AA may display content such as characters, pictures, videos, music, web pages, etc., the peripheral area PA may be generally provided with a drive circuit for driving the active area AA to work normally as well as a signal bus line, etc., and the peripheral area PA surrounds the active area AA typically.

The first substrate 110 and the second substrate 120 are generally both light-transmitting material substrates such as glass substrates, plastic substrates, etc. The first substrate 110 and the second substrate 120 are disposed oppositely, and corresponding circuits may be disposed between the first substrate 110 and the second substrate 120.

The pixel array substrate 130 is disposed on the first substrate 110 and located in the active area AA, and under drive control of the drive circuit 140, the pixel array circuit 130 may generate a control signal to control display of the display panel. Typically, the pixel array circuit 130 includes an active switch element array and a pixel electrode array connected to the active switch element array.

The drive circuit 140 is disposed on the first substrate 110 and located in the peripheral area PA, and the drive circuit 140 is connected to the pixel array circuit 130 and is used for driving the pixel array circuit 130. Since a gate electrode driver of the present embodiment adopts the GOA circuit, the drive circuit 140 in the present embodiment includes a GOA circuit 141, the GOA circuit 141 is disposed on the first substrate 110 and located in the peripheral area PA, and the GOA circuit 141 is connected to the pixel array circuit 130 and is used for driving the pixel array circuit 130. Correspondingly, the isolating structure 160 faces the GOA circuit 141 and isolates the GOA circuit 141 from the liquid crystal layer 150, so as to form a liquid crystal-free area between the GOA circuit 141 and the second substrate 120. Further, it is mentionable that the GOA circuit 141 typically includes cascaded shift registers, and the shift register of each cascade is connected to a scan line in the active area AA.

After the isolating structure 160 isolates the GOA circuit 141 from the liquid crystal layer 150, the polarization of ions in the liquid crystal layer 150 will not affect the GOA circuit 141. Therefore, the liquid crystal layer 150 will not affect actions of the GOA circuit 141, and further the stability of the actions of the GOA circuit 141 can be enhanced.

In one implementing manner of the present embodiment, the pixel array circuit 130 includes a thin film transistor array and a transparent ITO pixel electrode array, the thin film transistor array includes a plurality of thin film transistors, and the GOA circuit 141 provides a voltage for gate electrodes of the plurality of thin film transistors. These thin film transistors may be a-Si (amorphous silicon) thin film transistors or poly-Si (polycrystalline silicon) thin film transistors, wherein the poly-Si thin film transistors may be formed by adopting a low temperature poly-silicon technology, and the like.

As shown in FIG. 3, the drive circuit 140 further includes a signal bus line 142, the signal bus line 142 is disposed on the first substrate 110 and located in the peripheral area PA, and the signal bus line 142 is connected to the GOA circuit 141 and located on one side of the GOA circuit 141 away from the active area AA. In the present embodiment, the isolating structure 160 further faces the signal bus line 142 and isolates the signal bus line 142 from the liquid crystal layer 150, to form a liquid crystal-free area between the signal bus line 142 and the second substrate 120. The signal bus line 142 for example is used for providing a clock signal for the GOA circuit 141.

After the isolating structure 160 isolates the signal bus line 142 from the liquid crystal layer 150, the signal bus line 142 will not be affected by the polarization of ions in the liquid crystal layer 150. Since the GOA circuit 141 and the signal bus line 142 are both not affected by the polarization of the ions in the liquid crystal layer 150, the signal bus line 142 will not be affected by coupling, and the direct current residual is avoided.

As shown in FIG. 3, the isolating structure 160 includes a plurality of photosensitive spacers (Photo Spacer) 161, and the plurality of photosensitive spacers 161 are uniformly distributed on the second substrate 120 and are fixedly connected to the second substrate 120. The photosensitive spacers 161 are generally formed on the second substrate 120 by photosensitive resin through a photolithography process, the photosensitive resin can effectively isolate the liquid crystal molecules when formed above the drive circuit 140 with a proper density, the present embodiment is not limited to such material and other proper materials may be adopted. The photosensitive spacers 161 are equidistantly disposed, and the photosensitive spacers 161 all face the GOA circuit 141 and the signal bus line 142, such that the GOA circuit 141 and the signal bus line 142 are isolated from the liquid crystal layer 150.

In one implementing manner of the present embodiment, as shown in FIG. 3, the drive circuits 140 are respectively located on both sides of the active area AA, and may be located in a left peripheral area PA and a right peripheral area PA. Each of the left peripheral area PA and the right peripheral area PA has the GOA circuit 141 and the signal bus line 142 therein, in one typical solution of the present embodiment, the GOA circuit 141 in the left peripheral area PA and the GOA circuit 141 in the right peripheral area PA are located on two opposite sides of the pixel array circuit 130, that is, the two are disposed oppositely. It should be noted that in actual application, in order to meet special requirements, the same side of the pixel array circuit 130 may be provided with a plurality of GOA circuits 141.

As mentioned above, in the present embodiment, the liquid crystal display panel 100 further includes: a light filter layer 170, wherein the light filter layer 170 is disposed on the second substrate 120 and corresponds to the active area AA; and a plurality of disperse photosensitive spacers 180, wherein the plurality of disperse photosensitive spacers 180 for example are disposed between the pixel array circuit 130 in the active area AA and the light filter layer 170, and used for maintaining a proper gap (or called as liquid crystal cell gap) between the light filter layer 170 and the pixel array circuit 130. In a case of adopting the photosensitive spacers 161, the isolating structure 160 may be formed by using the same material and in the same process as the photosensitive spacers 180, such that a manufacturing cost of the isolating structure 160 can be reduced. It is mentionable that a distribution density of the photosensitive spacers 161 for forming the isolating structure 160 in the peripheral area PA is larger than that of the photosensitive spacers 180 for maintaining the liquid crystal cell gap in the active area AA.

In the present embodiment, the photosensitive spacers 180 corresponding to the active area AA are second spacers. The second spacers extend to the pixel array circuit 130 from the light filter layer 170, and are adjacent to the liquid crystal molecules.

The light filter layer 170 includes a plurality of color photoresists, the plurality of color photoresists may be red (R), green (G) and blue (B) color photoresists, and the light filter layer 170 is disposed on the second substrate 120. Of course, in another implementing manner, in order to increase an aperture ratio, the light filter layer 170 may also be disposed on the first substrate 110. Therefore, the light filter layer 170 is located between the liquid crystal layer 150 and an active switch element array for example a thin film transistor array.

The light filter layer 170 may process light rays, and after the light generated by control of the pixel array circuit 130 passes by the light filter layer 170, the liquid crystal display panel can display corresponding content, including fonts, pictures, animals and plants of corresponding colors as well as various colors, etc.

Wherein, the number of the plurality of disperse photosensitive spacers 180 is three or more, and the plurality of disperse photosensitive spacers 180 are distributed at equal intervals. The plurality of spacers 180 distributed at equal intervals can enable the gap between the light filter layer 170 and the pixel array circuit 130 to be kept stable. In one implementing solution of the present embodiment, as shown in FIG. 3, the light filter layer 170 generally includes a red color photoresist, a green color photoresist and a blue color photoresist (the letters, R, G and B in FIG. 3 respectively represent the corresponding red color photoresist, the corresponding green color photoresist and the corresponding blue color photoresist). Therefore, in the present embodiment, the plurality of disperse photosensitive spacers 180 are disposed to correspond to the red color photoresist R, the green color photoresist G and the blue color photoresist B in a one-to-one manner. In other implementing manners, since human eyes are more sensitive to green light but less sensitive to blue light, the photosensitive spacers 180 may be correspondingly disposed only for the blue color photoresist B in the active area AA, while no photosensitive spacers 180 are correspondingly disposed for the red color photoresist R and the green color photoresist G.

The present embodiment further provides a liquid crystal display device 300, as shown in FIG. 4, including a backlight module 200 and the liquid crystal display panel 100 as mentioned above, and the backlight module 200 is used for providing backlight illumination for the liquid crystal display panel 100.

It should be pointed out that the liquid crystal display device 300 may further include other corresponding components, such as frames, power source interfaces, data interfaces, etc.

The liquid crystal display device 300 may be various liquid crystal display screens, such as television liquid crystal display screens, computer liquid crystal display screens, etc.

Based on the above content, it can be known that the liquid crystal display panel 100 includes the first substrate, having a active area and a peripheral area; the second substrate, opposite to the first substrate; the pixel array circuit, disposed on the first substrate and located in the active area; the drive circuit, disposed on the first substrate and located in the peripheral area, wherein the drive circuit is connected to the pixel array circuit and is used for driving the pixel array circuit; the liquid crystal layer, disposed between the first substrate and the second substrate, wherein the liquid crystal layer includes a plurality of liquid crystal molecules and the pixel array circuit is used for controlling actions of the plurality of liquid crystal molecules; and the isolating structure, disposed on the second substrate and facing the drive circuit, wherein the isolating structure is used for isolating the drive circuit from the liquid crystal layer. The liquid crystal display device 300 in the present embodiment is based on the above liquid crystal display panel 100. Therefore, by disposing the isolating structure in the liquid crystal display panel, the drive circuit is isolated from the liquid crystal layer, the influence on the drive circuit caused by the polarization of ions of the liquid crystal layer can be avoided while the drive circuit is used to drive the pixel array circuit to control actions of the liquid crystal molecules so as to enable the liquid crystal layer to work, further, the DC residual caused when the drive circuit drives the pixel array circuit is avoided, and therefore, a display effect of the liquid crystal display device can be further enhanced.

Wherein, the drive circuit 140 includes a GOA circuit 141 as a gate electrode driver, the GOA circuit 141 is disposed on the first substrate 110 and located in the peripheral area PA, and the GOA circuit 141 is connected to the pixel array circuit 130 and is used for driving the pixel array circuit 130. Correspondingly, the isolating structure 160 faces the GOA circuit 141 and isolates the GOA circuit 141 from the liquid crystal layer 150, so as to form a liquid crystal-free area between the GOA circuit 141 and the second substrate 120, in other words, a liquid crystal-free area is formed above the GOA circuit 141.

After the isolating structure 160 isolates the GOA circuit 141 from the liquid crystal layer 150, the polarization of ions in the liquid crystal layer 150 will not affect the GOA circuit 141. Therefore, the liquid crystal layer 150 will not affect actions of the GOA circuit 141, further the stability of the actions of the GOA circuit 141 can be enhanced, and the display effect of the liquid crystal display device 300 is further improved.

As shown in FIG. 3, the drive circuit 140 further includes a signal bus line 142, the signal bus line 142 is disposed on the first substrate 110 and located in the peripheral area PA, and the signal bus line 142 is connected to the GOA circuit 141 and located on one side of the GOA circuit 141 away from the active area AA. In the present embodiment, the isolating structure 160 further faces the signal bus line 142 and isolates the signal bus line 142 from the liquid crystal layer 150. After the isolating structure 160 isolates the signal bus line 142 from the liquid crystal layer 150, the signal bus line 142 will not be affected by polarization of the ions in the liquid crystal layer 150. Since the GOA circuit 141 and the signal bus line 142 are both not affected by the polarization of the ions in the liquid crystal layer 150, the signal bus line 142 will not be affected by coupling, and direct current residual is avoided.

It can be known from above that the isolating structure 160 isolates the GOA circuit 141 and the signal bus line 142 from the liquid crystal layer 150, direct current residual can be avoided, and further the display stability of the liquid crystal display device 300 is enhanced.

In order to enhance the color display effect of the liquid crystal display device 300, in the present embodiment, the liquid crystal display panel 100 that the liquid crystal display device includes further includes: a light filter layer 170, wherein the light filter layer 170 is disposed on the second substrate 120 and corresponds to the active area AA; and a plurality of disperse photosensitive spacers 180, wherein the plurality of disperse photosensitive spacers 180 are disposed between the pixel array circuit 130 in the active area AA and the light filter layer 170, and used for maintaining a proper gap (or liquid crystal cell gap) between the light filter layer 170 and the pixel array circuit 130. In a case of adopting the photosensitive spacers 161, the isolating structure 160 may be formed by using the same material and in the same process as the photosensitive spacers 180, such that a manufacturing cost of the isolating structure 160 can be reduced. It is mentionable that a distribution density of the photosensitive spacers 161 for forming the isolating structure 160 in the peripheral area PA is larger than that of the photosensitive spacers 180 for maintaining the liquid crystal cell gap in the active area AA.

In the present embodiment, the photosensitive spacers 180 corresponding to the active area AA are second spacers. The second spacers extend to the pixel array circuit 130 from the light filter layer 170, and are adjacent to the liquid crystal molecules.

The light filter layer 170 includes a plurality of color photoresists, these color photoresists may be red, green and blue color photoresists, and the light filter layer 170 is disposed on the second substrate 120. Of course, in another implementing manner, in order to increase an aperture ratio, the light filter layer 170 may also be disposed on the first substrate 110. Therefore, the light filter layer 170 is located between the liquid crystal layer 150 and an active switch element array for example a thin film transistor array of the pixel array circuit 130.

The light filter layer 170 may process light rays, and after the light generated by control of the pixel array circuit 130 passes by the light filter layer 170, the liquid crystal display panel 100 can display corresponding content, including fonts, pictures, animals and plants of corresponding colors as well as various colors, etc.

Wherein, the number of the plurality of disperse photosensitive spacers 180 is three or more, and the plurality of disperse photosensitive spacers 180 are distributed at equal intervals. The plurality of disperse photosensitive spacers 180 distributed at equal intervals can enable the gap between the light filter layer 170 and the pixel array circuit 130 to be kept stable. In one implementing solution of the present embodiment, as shown in FIG. 3, since the light filter layer 170 generally includes a red color photoresist, a green color photoresist and a blue color photoresist (the letters, R, G and B respectively represent the red color photoresist, the green color photoresist and the blue color photoresist), in the present embodiment, the plurality of disperse photosensitive spacers 180 are set to correspond to the red color photoresist R, the green color photoresist G and the blue color photoresist B in a one-to-one manner. In other implementing manners, since human eyes are more sensitive to green light but less sensitive to blue light, the photosensitive spacers 180 may be correspondingly disposed only for the blue color photoresist B in the active area AA, while no photosensitive spacers 180 are correspondingly disposed for the red color photoresist R and the green color photoresist G.

Meanwhile, it can be known from above that the liquid crystal display device 300 of the present embodiment may realize the narrow frame by a GOA technology.

In addition, it is mentionable that the isolating structure 160 of the aforesaid embodiment of the present application is not limited to include a plurality of photosensitive spacers 161, and may adopt the spacers of other materials, and even may adopt the structures of other shapes as long as the purpose of isolating the drive circuit from the liquid crystal layer to form the liquid crystal-free area above the drive circuit can be realized.

Finally, it is mentionable that in other embodiments, the aforesaid liquid crystal display panel 100 may be re-divided to include the components of an array substrate, an opposed substrate, the liquid crystal layer 150 and the sealant 190, etc., the sealant 190 is disposed between the array substrate and the opposed substrate and forms a containing space together with the array substrate and the opposed substrate, and the liquid crystal layer 150 is located between the array substrate and the opposed substrate and located in the containing space, wherein the array substrate for example includes the first substrate 110, the pixel array circuit 130 and the drive circuit 140, the opposed substrate includes the second substrate 120 and the light filter layer 170, the drive circuit 140 is located in the liquid crystal-free area in the containing space, the isolating structure 160 is located in the liquid crystal-free area in the containing space, is fixedly connected to the opposed substrate and faces the drive circuit 140, and the photosensitive spacers 180 are located in the active area AA where the liquid crystal layer 150 in the containing space is. In short, the containing space may be divided into a liquid crystal area and a liquid crystal-free area in parallel in a vertical direction (a horizontal direction in FIG. 3) of an interval direction of the array substrate and the opposed substrate, and the liquid crystal-free area surrounds and encircles the liquid crystal area. The isolating structure 160 is located in the liquid crystal-free area and is opposite to and spaced from the drive circuit 140, the photosensitive spacers 180 are located in the liquid crystal area, and the liquid crystal layer 150 is located in the liquid crystal area. In addition it is understandable that in another embodiment, the light filter layer 170 may serve as a constituent part of the array substrate rather than the opposed substrate.

Finally, it should be noted that the above embodiments are merely illustrative of the technical solutions of the present disclosure and are not intended to be limiting thereof. For the person skilled in the art of the disclosure, without departing from the concept of the disclosure, simple deductions or substitutions can be made and should be included in the protection scope of the disclosure.

What is claimed is:

1. A liquid crystal display panel, comprising:
an array substrate, comprising a drive circuit;
an opposed substrate, opposite to the array substrate;
a sealant, disposed between the array substrate and the opposed substrate, wherein the array substrate, the opposed substrate and the sealant define a containing space together, the containing space comprises a liquid crystal area and a liquid crystal-free area in parallel, and the drive circuit is located in the liquid crystal-free area; and
liquid crystal molecules, distributed in the liquid crystal area.

2. The liquid crystal display panel according to claim 1, further comprising an isolating structure, wherein the isolating structure is located above the drive circuit and is spaced from the drive circuit, and the isolating structure is located in the liquid crystal-free area.

3. The liquid crystal display panel according to claim 2, wherein the isolating structure is of a plurality of spacers, and the plurality of spacers are fixedly connected to the opposed substrate, and extend to the drive circuit from the opposed substrate.

4. The liquid crystal display panel according to claim 3, wherein the plurality of spacers are photosensitive spacers.

5. The liquid crystal display panel according to claim 1, wherein the array substrate comprises a pixel array circuit, the pixel array circuit is located in the liquid crystal area, and the drive circuit is connected to the pixel array circuit.

6. The liquid crystal display panel according to claim 5, wherein the drive circuit comprises an array substrate upper gate electrode driver, and the array substrate upper gate electrode driver is connected to the pixel array circuit.

7. The liquid crystal display panel according to claim 6, wherein the drive circuit further comprises a signal bus line, the signal bus line is connected to the array substrate upper gate electrode driver, and the signal bus line is used for providing a clock signal for the array substrate upper gate electrode driver.

8. The liquid crystal display panel according to claim 7, wherein the array substrate upper gate electrode driver is located between the signal bus line and the pixel array circuit.

9. The liquid crystal display panel according to claim 1, wherein the opposed substrate comprises a light filter layer, and the light filter layer is located in the liquid crystal area.

10. The liquid crystal display panel according to claim 9, wherein the light filter layer comprises a red color photoresist, a green color photoresist and a blue color photoresist.

11. The liquid crystal display panel according to claim 9, further comprising a plurality of second spacers, wherein the plurality of second spacers are located in the liquid crystal area and extend to the pixel array circuit from the light filter layer, and the second spacers are used for maintaining a proper gap between the light filter layer and the pixel array circuit.

12. The liquid crystal display panel according to claim 11, wherein the light filter layer comprises a red color photoresist, a green color photoresist and a blue color photoresist, and the red color photoresist, the green color photoresist and the blue color photoresist correspond to the second spacers in a one-to-one manner.

13. The liquid crystal display panel according to claim 9, wherein the plurality of liquid crystal molecules are located between the light filter layer and the pixel array circuit.

14. The liquid crystal display panel according to claim 9, wherein the plurality of liquid crystal molecules are located between the light filter layer and the pixel array circuit, the liquid crystal display panel further comprises a plurality of second spacers, the plurality of second spacers are located in the liquid crystal area and extend to the pixel array circuit from the light filter layer, and the second spacers are adjacent to the liquid crystal molecules.

15. A liquid crystal display device, comprising:
a backlight module, used for providing backlight illumination; and
a liquid crystal display panel, comprising:
an array substrate, comprising a drive circuit;
an opposed substrate, opposite to the array substrate;
a sealant, disposed between the array substrate and the opposed substrate, wherein the array substrate, the opposed substrate and the sealant define a containing space together, the containing space comprises a liquid crystal area and a liquid crystal-free area, and the drive circuit is located in the liquid crystal-free area; and
liquid crystal molecules, distributed in the liquid crystal area.

16. The liquid crystal display device according to claim 15, further comprising an isolating structure, wherein the isolating structure is located above the drive circuit and is spaced from the drive circuit, and the isolating structure is located in the liquid crystal-free area.

17. The liquid crystal display device according to claim 16, wherein the array substrate comprises a pixel array circuit, the pixel array circuit is located in the liquid crystal area, and the drive circuit is connected to the pixel array circuit.

18. The liquid crystal display panel according to claim 17, wherein the opposed substrate comprises a light filter layer, and the light filter layer is located in the liquid crystal area, the plurality of liquid crystal molecules are located between the light filter layer and the pixel array circuit, a plurality of second spacers, wherein the plurality of second spacers are located in the liquid crystal area and extend to the pixel array circuit from the light filter layer, and the liquid crystal display panel also comprises a plurality second spacers, the plurality of second spacers are located in the liquid crystal area and extend to the pixel array circuit from the light filter layer.

19. The liquid crystal display panel according to claim 17, wherein the liquid crystal-free area surrounds the liquid crystal area.

20. A liquid crystal display device, comprising:
a backlight module, used for providing backlight illumination; and
a liquid crystal display panel, comprising:
an first substrate, comprising an active area and a peripheral area;
a second substrate, opposite to the first substrate;
an opposed substrate, opposite to the array substrate;
a pixel array circuit, disposed on the active area of the first substrate;
a drive circuit, disposed on the peripheral area of the first substrate, wherein the drive circuit is connected to drive the pixel array circuit;
a liquid crystal layer, disposed between the active area of the first substrate and the second substrate, wherein the liquid crystal layer comprises liquid crystal molecules, the pixel array circuit is used for controlling the plurality of liquid crystal molecules;
an isolating structure, disposed on the second substrate and corresponding to the peripheral area, wherein the isolating structure is used for isolating the drive circuit and the liquid crystal layer; and
a sealant, disposed on the peripheral area of the first substrate and the second substrate, wherein the first substrate, the second substrate and the sealant define a containing space together, and the drive circuit and the isolating structure are located in the liquid crystal-free area.
